(19) United States
(12) Patent Application Publication
(10) Pub. No.: US 2012/0320099 A1
(43) Pub. Date: Dec. 20, 2012

(54) PIXEL CIRCUIT AND FLAT DISPLAY PANEL USING THE SAME

(75) Inventors: Yu-Ching WU, Hsin-chu (TW); Tien-Lun TING, Hsin-Chu (TW); Kun-Cheng TIEN, Hsin-Chu (TW); Chien-Huang LIAO, Hsin-Chu (TW); Wen-Hao HSU, Hsin-Chu (TW)

(73) Assignee: AU OPTRONICS CORP., Hsinchu (TW)

(21) Appl. No.: 13/344,681

(22) Filed: Jan. 6, 2012

(30) Foreign Application Priority Data
Jun. 15, 2011 (TW) 100120957

(51) Int. Cl. G09G 5/10

(52) U.S. Cl. 345/690

(57) ABSTRACT

An exemplary pixel circuit and a flat display panel using the same are provided. The pixel circuit includes three sub-electrode control circuits. The sub-electrode control circuits are controlled by two scan lines to receive data transmitted from two data lines. One of the three sub-electrode control circuits adjusts stored data by charge sharing. Accordingly, a display control of the pixel circuit is achieved by the three sub-electrode control circuits.

### TECHNICAL FIELD

The disclosure relates to pixel circuits and flat display panels using the same, and more particularly to a pixel circuit that is capable of improving the color washout phenomenon appeared under side view angles of flat display panels and a flat display panel using the same.

### BACKGROUND

Nowadays, liquid crystal display (LCD) devices are a kind of widely used flat display device. According to different driving modes, LCD devices can be divided into three kinds of twisted nematic (TN) LCD device, vertical alignment (VA) LCD device and In Plane Switching (IPS) LCD device.

The TN LCD device is the firstly developed kind of LCD device. Advantages of such TN LCD device are that it is cheaper and has higher response rate. However, a view angle range of the TN LCD device is narrow. Compared with the TN LCD device, the VA LCD device and the IPS LCD device can provide wider view angle ranges, and therefore become preferred driving modes for display devices with large screens.

However, although the VA LCD device has wider view angle than the TN LCD device, the VA LCD device generally has a drawback that it may generate color washout at its side view angles. In order to overcome the drawback, a conventional method generally is to divide each pixel circuit of an LCD device into two sub-pixels and use suitable circuit designs to make pixel voltages of the two sub-pixels to be different from each other so as to cause the two sub-pixels to generate different luminance. However, referring to FIG. 1, the aforementioned conventional method can effectively limit luminance of the sub-pixels to be about gamma 2.2 only at certain grey levels. It is obvious that such an improving effect is not satisfactory. Therefore, many researchers are still dedicating themselves to relevant researches for improving color washout phenomenon generated at side view angles of flat display panels.

### SUMMARY OF EMBODIMENTS

Accordingly, an embodiment of the disclosure provides a pixel circuit electrically coupled to successively arranged a first data line and a second data line and further electrically coupled to successively arranged a first scan line and a second scan line. The pixel circuit includes a first sub-electrode control circuit, a second sub-electrode control circuit and a third sub-electrode control circuit. The first sub-electrode control circuit is electrically coupled to the first data line and the first scan line. The first sub-electrode control circuit is for receiving data transmitted from the first data line and thereby controlling transparency of a first pixel area according to the received data from the first data line. The second sub-electrode control circuit is electrically coupled to the second data line and the first scan line. The second sub-electrode control circuit is for receiving data transmitted from the second data line and thereby controlling transparency of a second pixel area according to the received data from the second data line. The third sub-electrode control circuit is electrically coupled to the second data line, the first scan line and the second scan line. The third sub-electrode control circuit is for receiving the data transmitted from the second data line, changing the received data from the second data line by charge sharing subjected to the control of the second scan line and thereby controlling transparency of a third pixel area according to the changed data. Moreover, a time of the second scan line being enabled is posterior to a time of the first scan line being enabled.

Another embodiment of the disclosure provides a flat display panel including multiple scan lines, multiple data lines and multiple pixel circuits. At least one of the pixel circuits each is electrically coupled to a first data line and a second data line arranged adjacent to the first data line among the multiple data lines and further electrically coupled to a first scan line and a second scan line arranged adjacent to the first scan line among the multiple scan lines. The at least one pixel circuit each includes a first sub-electrode control circuit, a second sub-electrode control circuit and a third sub-electrode control circuit. The first sub-electrode control circuit is electrically coupled to the first data line and the first scan line. The first sub-electrode control circuit is for receiving data transmitted from the first data line and controlling transparency of a first pixel area according to the received data from the first data line. The second sub-electrode control circuit is electrically coupled to the second data line and the first scan line and for receiving data transmitted from the second data line and controlling transparency of a second pixel area according to the received data from the second data line. The third sub-electrode control circuit is electrically coupled to the second data line, the first scan line and the second scan line and for receiving the data transmitted from the second data line, changing the received data from the second data line by charge sharing subjected to the control of the second scan line and thereby controlling transparency of a third pixel area according to the changed data. Moreover, the second scan line and the first scan line are sequentially enabled, and the second scan line is enabled after the first scan line is enabled.

### BRIEF DESCRIPTION OF THE DRAWINGS

The above embodiments of the disclosure will become more readily apparent to those ordinarily skilled in the art after reviewing the following detailed description and accompanying drawings.

FIG. 1 is a curve diagram of a relationship between luminance and grey levels at 45 degrees side view angle of a flat display panel using a conventional method of improving color washout phenomenon.

FIG. 2 is a schematic block diagram of a flat display panel according to an exemplary embodiment of the disclosure.

FIG. 3 is a schematic block diagram of a pixel circuit according to an exemplary embodiment of the disclosure.

FIG. 4 is a schematic circuit diagram of a pixel circuit according to an exemplary embodiment of the disclosure.

FIG. 5A is a curve diagram of a relationship between luminance and grey levels at 45 degrees side view angle of a flat display panel in two-dimensional (2D) display mode according to an exemplary embodiment of the disclosure.

FIG. 5B is a curve diagram of a relationship between luminance and grey levels at 45 degrees side view angle of a flat display panel in three-dimensional (3D) display mode according to an exemplary embodiment of the disclosure.

FIG. 6 is a schematic block diagram of a flat display panel according to another exemplary embodiment of the disclosure.

### DETAILED DESCRIPTION OF EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

Referring to FIG. 2, FIG. 2 is a schematic block diagram of a flat display panel 20 according to an exemplary embodiment of the disclosure. In this embodiment, the flat display panel 20 includes multiple scan lines e.g., G₁, G₂, . . . , G₂ₙ₋₁, and G₂ₙ, multiple data lines e.g., D₁, D₂, D₃, . . . D₂ₘ₋₁, and D₂ₘ, and multiple pixel circuits e.g., P_{(1,1)}, P_{(1,2)}, . . . , and P_{(n,m)}. In detail, the pixel circuit P_{(X,Y)} means the pixel circuit located at Xth row and Yth column. For example, the pixel circuits in the first row are respectively labeled as P_{(1,1)}, P_{(1,2)}, . . . , and P_{(1,m)}; the pixel circuits in the nth row are respectively labeled as P_{(n,1)}, P_{(n,2)}, . . . , and P_{(n,m)}. Similarly, the pixel circuits in the first column are respectively labeled as P_{(1,1)}, P_{(2,1)}, P_{(3,1)}, . . . , and P_{(n,1)}; the pixel circuits in the second column are respectively labeled as P_{(1,2)}, P_{(2,2)}, P_{(3,2)}, . . . , and P_{(n,2)}; and the pixel circuits in the mth column are respectively labeled as P_{(1,m)}, P_{(2,m)}, P_{(3,m)}, . . . , and P_{(n,m}).

As shown in FIG. 2, each of the pixel circuits P_{(1,1)}, P_{(1,2)}, . . . , and P_{(n,m)} is electrically coupled to adjacent two of the scan lines G₁, G₂, . . . , G₂ₙ₋₁, and G₂ₙ and adjacent two of the data lines D₁, D₂, D₃, . . . D₂ₘ₋₁, and D₂ₘ. For example, the pixel circuit P_{(1,1)} is electrically coupled to the successively arranged scan lines G₁, G₂ and the successively arranged data lines D₁, D₂; and the pixel circuit P_{(2,1)} is electrically coupled to the successively arranged scan lines G₃, G₄ and the successively arranged data lines D₁, D₂. An operation relationship among the scan lines and the data lines of any one of the pixel circuits electrically coupled thereto will be described in detail as follows.

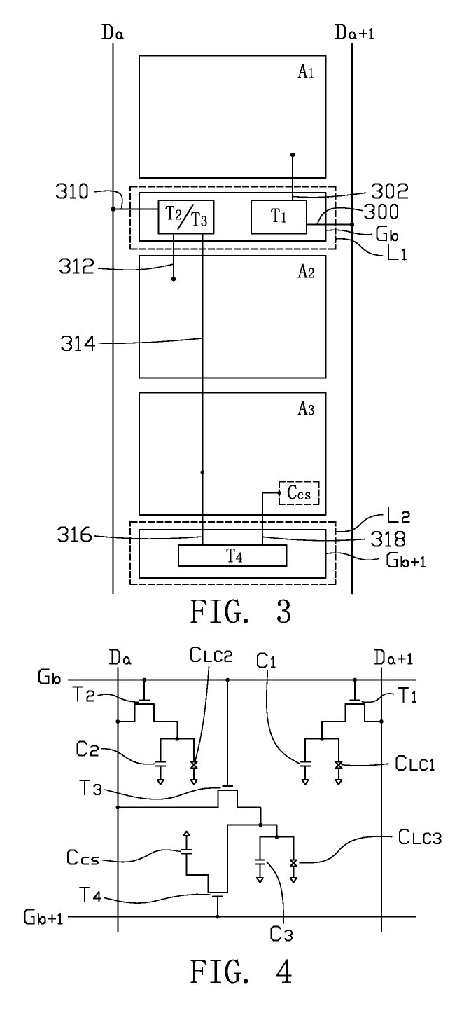

Referring to FIG. 3, FIG. 3 is a schematic block diagram of any one of the aforementioned pixel circuits P_{(1,1)}, P_{(1,2)}, . . . , and P_{(n,m)} according to an exemplary embodiment of the disclosure. As shown in FIG. 3, the pixel circuit includes three pixel areas A₁, A₂ and A₃, two wiring areas L₁ and L₂, multiple transistors T₁, T₂, T₃ and T₄, a charge sharing capacitor C_{CS}, and multiple conductive wires 300, 302, 310, 312, 314, 316 and 318. The transistors T₁, T₂ and T₃ are arranged in the wiring area L₁, and the transistor T₄ is arranged in the wiring area L₂. The pixel circuit in FIG. 3 is electrically coupled to two adjacent data lines Dₐ and Dₐ₊₁ and two adjacent scan lines G_{b} and G_{b+1}. Additionally, a scanning order of scan line is that the scan line G_{b+1} is enabled after the scan line G_{b} has already been enabled. That is, the time of the scan line G_{b+1} being enabled is posterior to the time of the scan line G_{b} being enabled. Furthermore, the pixel areas A₁, A₂ and A₃ are all arranged between the data lines Dₐ and Dₐ₊₁. The pixel areas A₁ and A₂ are respectively arranged at two sides of the scan line G_{b}. The pixel areas A₂ and A₃ both are arranged between the scan lines G_{b} and G_{b+1}.

In this embodiment, the pixel circuit includes three sub-electrode control circuits, i.e., a first sub-electrode control circuit, a second sub-electrode control circuit and a third sub-electrode control circuit. The first sub-electrode control circuit of the pixel circuit is defined as to include the transistor T₁ and the conductive wires 300, 302. The transistor T₁ is electrically coupled to the data line Dₐ₊₁ through the conductive wire 300. The scan line G_{b} controls the transistor T₁ to determine whether to receive data transmitted from the data line Dₐ₊₁ or not. Data received by the transistor T₁ is inputted to the first sub-electrode control circuit through the conductive wire 302 and stored in the first sub-electrode control circuit. Generally, the data received by the transistor T₁ can be stored in a capacitor (not shown) arranged in the pixel area A₁ or at an edge of the pixel area A₁ and an electric potential is representative of the stored data in the first sub-electrode control circuit. Transparency of the pixel area A₁ is affected by a electric potential difference between the electric potential of the stored data and a common electric potential of the flat display panel 20. In other words, because the common electric potential of the flat display panel 20 is usually fixed at a certain period, the first sub-electrode control circuit can be regarded as to control the transparency of the pixel area A₁ according to the received data from the data line Dₐ₊₁.

Similarly, the second sub-electrode control circuit of the pixel circuit is defined as to include the transistor T₂ and the conductive wires 310, 312. The transistor T₂ is electrically coupled to the data line Dₐ through the conductive wire 310. The scan line G_{b} controls the transistor T₂ to determine whether to receive data transmitted from the data line Dₐ or not. Data received by the transistor T₂ is inputted to the second sub-electrode control circuit through the conductive wire 312 and stored in the second sub-electrode control circuit. Generally, the data received by the transistor T₂ can be stored in a capacitor (not shown) arranged in the pixel area A₂ or at an edge of the pixel area A₂. Similar to that of the pixel area A₁, the second sub-electrode control circuit can be regarded as to control transparency of the pixel area A₂ according to the received data from the data line Dₐ.

The third sub-electrode control circuit of the pixel circuit is defined as to include the transistors T₃ and T₄, the charge sharing capacitor C_{CS} and the conductive wires 310, 314, 316 and 318. The transistor T₃ is electrically coupled to the data line Dₐ through the conductive wire 310. The scan line G_{b} controls the transistor T₃ to determine whether to receive data transmitted from the data line Dₐ or not. Data received by the transistor T₃ is inputted to the third sub-electrode control circuit through the conductive wire 314 and stored in the third sub-electrode control circuit. Generally, the data received by the transistor T₃ can be stored in a capacitor (not shown) arranged in the pixel area A₃ or at an edge of the pixel area A₃. Furthermore, the scan line G_{b+1} which is enabled after the scan line G_{b} is enabled controls the transistor T₄ to be turned on or off. When the transistor T₄ is turned on, the electric potential of the data stored in the third sub-electrode control circuit may be changed because the capacitor stored with the received data and the charge sharing capacitor C_{CS} may share charges with each other through the conductive wires 316 and 318. Therefore, the third sub-electrode control circuit can be regarded as to control transparency of the pixel area A₃ according to the data stored in the third sub-electrode control circuit. However, at different times, the aforementioned “data stored in the third sub-electrode control circuit” may be an electric potential of data just received from the data line Dₐ and stored in the third sub-electrode control circuit, or an electric potential of data that is stored in the third sub-electrode control circuit after charge sharing.

Referring to FIG. 4, FIG. 4 is a schematic circuit diagram of any one of the aforementioned pixel circuits according to an exemplary embodiment of the disclosure. On the whole, FIG. 4 can be regarded as an equivalent circuit diagram of the pixel circuit shown in FIG. 3, except that FIG. 4 shows some elements that are not shown in FIG. 3.

In the pixel circuit shown in FIG. 4, the first sub-electrode control circuit includes the transistor T₁ and further includes a storage capacitor C₁ and a liquid crystal capacitor C_{LC1}. The liquid crystal capacitor C_{LC1} is an equivalent representation of capacitance effect generated by positioning liquid crystal molecules between a positive electrode and a negative electrode. The transistor T₁ is electrically coupled to one of the positive electrode and the negative electrode, hereinafter also referred to as first sub-electrode. The transistor T₁ is further electrically coupled between the data line Dₐ₊₁ and the storage capacitor C₁. The transistor T₁ is still further electrically coupled to the scan line G_{b} and controlled to be turned on or off by an electric potential on the scan line G_{b}. Furthermore, the transistor T₁ is also electrically coupled between the data line Dₐ₊₁ and the liquid crystal capacitor C_{LC1}. Therefore, once the transistor T₁ is turned on, data transmitted from the data line Dₐ₊₁ (i.e., an electric potential on the data line Dₐ₊₁) is temporarily stored in the storage capacitor C₁ and the liquid crystal capacitor C_{LC1}.

The second sub-electrode control circuit includes the transistor T₂, a storage capacitor C₂ and a liquid crystal capacitor C_{LC2}, and has an operation process similar to that of the first sub-electrode control circuit. The transistor T₂ is electrically coupled between the data line Dₐ and the storage capacitor C₂. The transistor T₂ is further electrically coupled to the scan line G_{b} and controlled to be turned on or off by the electric potential on the scan line G_{b}. Furthermore, the transistor T₂ is also electrically coupled between the data line Dₐ and the liquid crystal capacitor C_{LC2}. That is, one terminal of the transistor T₂ is electrically coupled to an electrode of the liquid crystal capacitor C_{LC2}, hereinafter referred to as second sub-electrode. Therefore, once the transistor T₂ is turned on, the data transmitted from the data line Dₐ is temporarily stored in the storage capacitor C₂ and the liquid crystal capacitor C_{LC2}.

In the embodiment shown in FIG. 4, the third sub-electrode control circuit includes the transistors T₃ and T₄, a storage capacitor C₃, a liquid crystal capacitor C_{LC3} and the charge sharing capacitor C_{CS}. The transistor T₃ is electrically coupled between the data line Dₐ and the storage capacitor C₃. The transistor T₃ is further electrically coupled to the scan line G_{b} and controlled to be turned on or off by the electric potential on the scan line G_{b}. Furthermore, the transistor T₃ is also electrically coupled between the data line Dₐ and the liquid crystal capacitor C_{LC3}. That is, one terminal of the transistor T₃ is electrically coupled to an electrode of the liquid crystal capacitor C_{LC3}, hereinafter referred to as third sub-electrode. Therefore, once the transistor T₃ is turned on, the data transmitted from the data line Dₐ is temporarily stored in the storage capacitor C₃ and the liquid crystal capacitor C_{LC3}. The transistor T₄ is electrically coupled between the storage capacitor C₃ and the charge sharing capacitor C_{CS}. The transistor T₄ is further electrically coupled to the scan line G_{b+1} and controlled to be turned on or off by the electric potential on the scan line G_{b+1}. Furthermore, the transistor T₄ is also electrically coupled between the charge sharing capacitor C_{CS} and the liquid crystal capacitor C_{LC3}; that is, one terminal of the transistor T₄ is electrically coupled to the third sub-electrode. Once the transistor T₄ is turned on, the storage capacitor C₃, the liquid crystal capacitor C_{LC3} and the charge sharing capacitor C_{CS} can share charges with each other, and thus electric potentials of the storage capacitor C₃ and the liquid crystal capacitor C_{LC3} would be changed consequently.

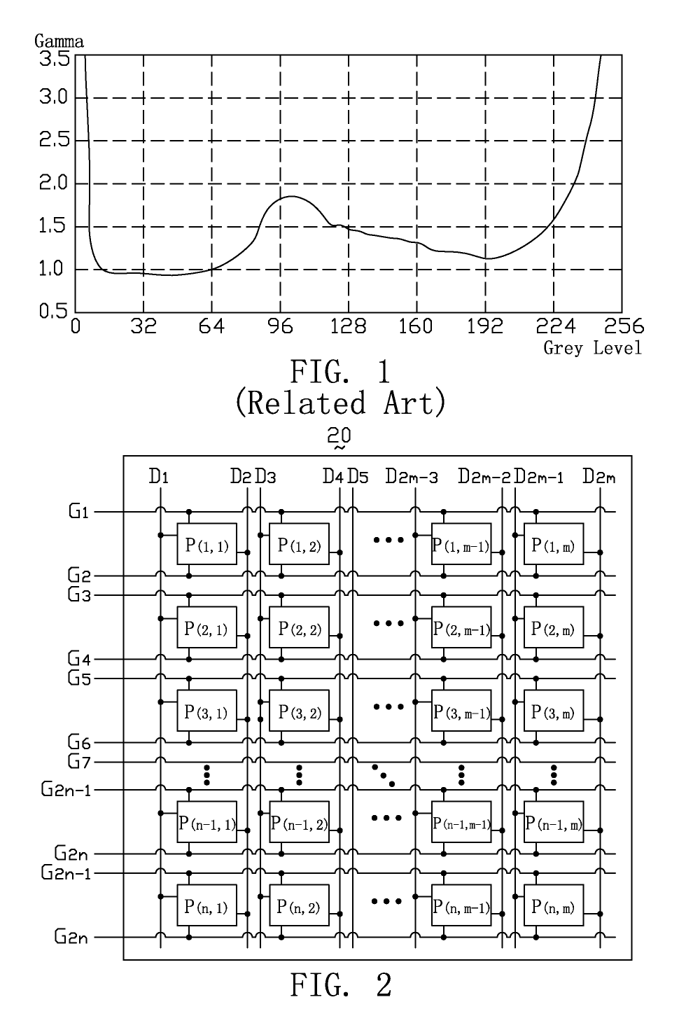

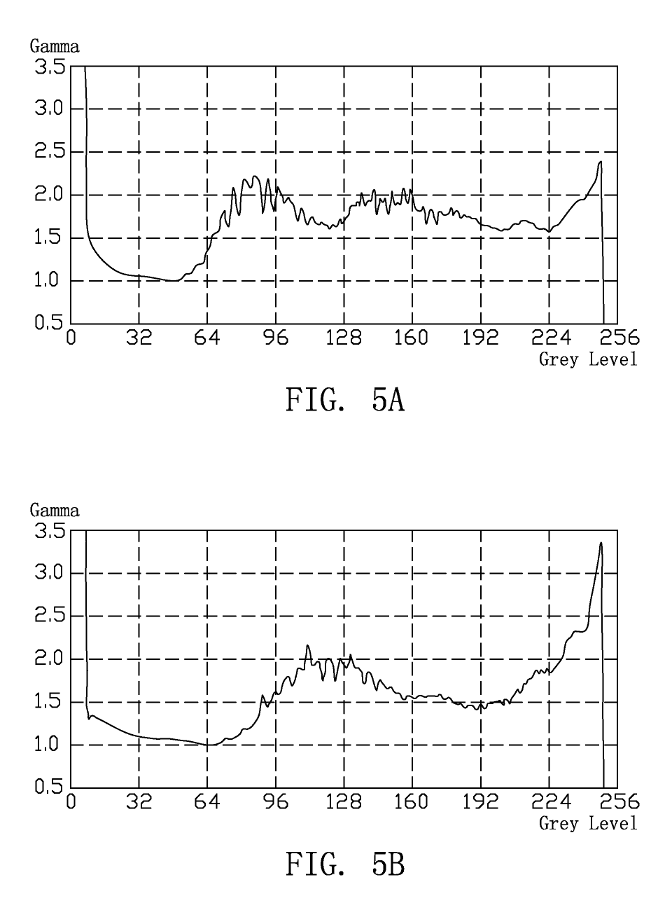

In short, in the disclosure, at most three different electric potentials are provided for producing three different kinds of luminance in one pixel circuit, and thus can obtain better side view effect in two-dimensional (2D) display mode than the prior art. Referring to FIG. 5A, FIG. 5A is a curve diagram of a relationship between luminance and grey levels at 45 degrees side view angle of the flat display panel in two-dimensional (2D) display mode. By comparing FIG. 5A with FIG. 1, it can be found that the luminance curve resulting from executing the present embodiment is more closer to the curve of Gamma 2.2, i.e., achieving better improving effect.

In another aspect, in three-dimensional (3D) display mode, the first sub-electrode circuit can be turned off to be prevented from displaying data. On the other hand, in the 3D display mode, the pixel area A1 shown in FIG. 3 can be controlled to display approximately black by means of turning off the first sub-electrode control circuit. In this way, light leakage at side view angles can be decreased. Referring to FIG. 5B, FIG. 5 is a curve diagram of a relationship between luminance and grey levels at 45 degrees side view angle of the flat display panel in three-dimensional (3D) display mode. Similarly, the luminance curve shown in FIG. 5B is more closer to the curve of Gamma 2.2 than that shown in FIG. 1, which indicates that the present embodiment can also achieve better improving effect in 3D display mode than the prior art.

Besides the single-domain vertical alignment (VA) liquid crystal display device, if the present pixel circuit is adopted in a multi-domain vertical alignment (MVA) liquid crystal display device, the MVA liquid crystal display device may have a twelve-domain (i.e., four domains*three pixel areas) side view optical effect in 2D display mode, and may have eight-domain (i.e., four domains*two pixel areas) side view optical effect in 3D display modes. That is, the present pixel circuit can also improve side view optical effects of the MVA liquid crystal display device in both 2D and 3D display modes.

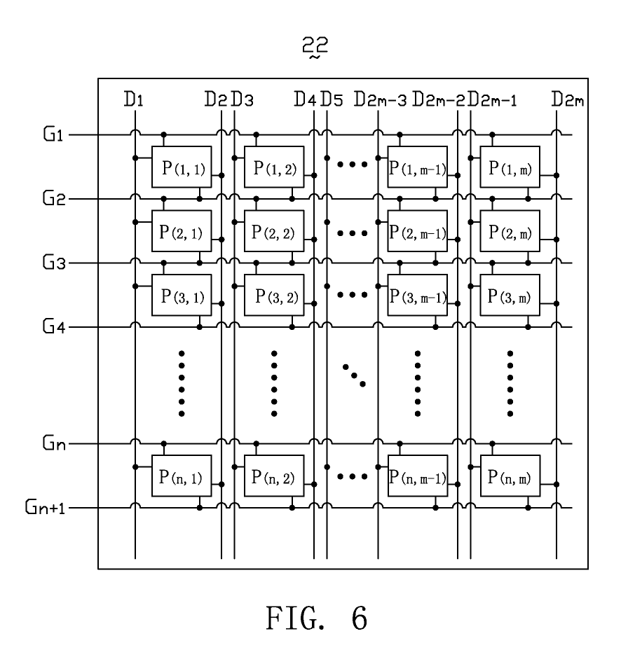

The aforementioned are several exemplary embodiments of the disclosure. It can be understood that, besides well-known modifications such as using other suitable switching elements to replace the transistors T₁, T₂, T₃ and T₄, the whole design of the flat display panels can also be modified. Referring to FIG. 6, FIG. 6 is a schematic block diagram of a flat display panel 22 according to another exemplary embodiment of the disclosure. As illustrated in FIG. 6, the circuit design of this embodiment is similar to that as shown in FIG. 2, the difference is that every two pixel circuits electrically coupled to the same two data lines in the flat display panel 20 shown in FIG. 2 are respectively electrically coupled to different scan lines, but in the flat display panel 22 as shown in FIG. 6, two adjacent pixel circuits electrically coupled to the same two data lines would share a same scan line.

For example, in FIG. 2 and FIG. 6, the two adjacent pixel circuits P_{(1,1)} and P_{(2,1)} are both electrically coupled to the data lines D₁ and D₂. However, in the flat display panel 20 as shown in FIG. 2, the pixel circuit P_{(1,1)} is electrically coupled to the scan lines G₁ and G₂, and the pixel circuit P_{(2,1)} is electrically coupled to the scan lines G₃ and G₄, that is, the scan lines electrically coupled to the pixel circuit P_{(1,1)} are completely different from the scan lines electrically coupled to the pixel circuit P_{(2,1)}. In the flat display panel 22 shown in FIG. 6, besides the pixel circuit P_{(1,1)} being electrically coupled to the scan line G₁ and the pixel circuits P_{(2,1)} being electrically coupled to the scan line G₃, the pixel circuits P_{(1,1)} and P_{(2,1)} are both electrically coupled to the another scan line G₂. Compared with the circuit design of FIG. 2, the circuit design of FIG. 6 can decrease a great number of scan lines and thus is more suitable for practical use.

Furthermore, in the various embodiments of the disclosure, an area of the pixel area A₁ is A1, an area of the pixel area A₂ is A2, and an area of the pixel area A₃ is A3. When the areas A1, A2 and A3 is in accord with the following relationship that:

$$\frac{A 1}{A 1 + A 2 + A 3} \leq 30 \% ,$$

### and A2≦A3,

luminance curves at side view in both 2D and 3D display modes are more approximate to the curve of gamma 2.2 as shown in FIG. 5A and FIG. 5B, and accordingly better display quality can be achieved. Moreover, it is indicated that, the value of [A1/(A1+A2+A3)] is not limited to be in the range of no more than 30%, and may be in a broader range e.g., from 10% to 70% according to some experimental results.

Sum up, the disclosure can improve side view optical effects in both 2D and 3D display modes, and the improving effect of the disclosure exceeds that of the conventional method. Accordingly, the disclosure is more suitable for practical use in products.

While the disclosure has been described in terms of what is presently considered to be the most practical and preferred embodiments, it is to be understood that the disclosure needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A pixel circuit electrically coupled to successively arranged a first data line and a second data line and further electrically coupled to successively arranged a first scan line and a second scan line, the pixel circuit comprising:
a first sub-electrode control circuit electrically coupled to the first data line and the first scan line, the first sub-electrode control circuit for receiving data transmitted from the first data line and thereby controlling transparency of a first pixel area according to the received data from the first data line;
a second sub-electrode control circuit electrically coupled to the second data line and the first scan line, the second sub-electrode control circuit for receiving data transmitted from the second data line and thereby controlling transparency of a second pixel area according to the received data from the second data line; and
a third sub-electrode control circuit electrically coupled to the second data line, the first scan line and the second scan line, the third sub-electrode control circuit for receiving the data transmitted from the second data line, changing the received data from the second data line by charge sharing subjected to the control of the second scan line and thereby controlling transparency of a third pixel area according to the changed data;
wherein a time of the second scan line being enabled is posterior to a time of the first scan line being enabled.

2. The pixel circuit according to claim 1, wherein
the first pixel area, the second pixel area and the third pixel area are arranged between the first data line and the second data line,
the first pixel area and the second pixel area are respectively arranged at two sides of the first scan line, and
the second pixel area and the third area are arranged between the first scan line and the second scan line.

3. The pixel circuit according to claim 1, wherein an area of the second pixel area is not larger than an area of the third pixel area.

4. The pixel circuit according to claim 1, wherein
the first sub-electrode control circuit comprises:
a first switching element;
a first sub-electrode electrically coupled to the first switching element; and
a first storage capacitor electrically coupled to the first switching element through the first sub-electrode;
wherein the first switching element is electrically coupled between the first data line and the first storage capacitor and further electrically coupled to the first scan line, to thereby receive the data transmitted from the first data line and store the received data from the first data line in the first storage capacitor;
the second sub-electrode control circuit comprises:
a second switching element;
a second sub-electrode electrically coupled to the second switching element; and
a second storage capacitor electrically coupled to the second switching element through the second sub-electrode;
wherein the second switching element is electrically coupled between the second data line and the second storage capacitor and further electrically coupled to the first scan line, to thereby receive the data transmitted from the second data line and store the received data from the second data line in the second storage capacitor; and
the third sub-electrode control circuit comprises:
a third switching element;
a fourth switching element;
a third sub-electrode electrically coupled to the third switching element and the fourth switching element;
a third storage capacitor electrically coupled to the third switching element through the third sub-electrode; and
a charge sharing capacitor electrically coupled to the fourth switching element;
wherein the third switching element is electrically coupled between the second data line and the third storage capacitor and further electrically coupled to the first scan line, to thereby receive the data transmitted from the second data line and store the received data from the second data line in the third storage capacitor;
wherein the fourth switching element is electrically coupled between the third storage capacitor and the charge sharing capacitor and further electrically coupled to the second scan line, to thereby control the third storage capacitor and the charge sharing capacitor to mutually share charges.

5. The pixel circuit according to claim 1, wherein when the pixel circuit is used for three-dimensional display, the first sub-electrode control circuit is kept in a turned-off state.

6. A flat display panel comprising:
a plurality of scan lines;
a plurality of data lines; and
a plurality of pixel circuits, at least one of the pixel circuits each electrically coupled to a first data line and a second data line arranged adjacent to the first data line among the plurality of data lines and further electrically coupled to a first scan line and a second scan line arranged adjacent to the first scan line among the plurality of scan lines; the at least one pixel circuit each comprising:
a first sub-electrode control circuit electrically coupled to the first data line and the first scan line and for receiving data transmitted from the first data line and controlling transparency of a first pixel area according to the received data from the first data line;
a second sub-electrode control circuit electrically coupled to the second data line and the first scan line and for receiving data transmitted from the second data line and controlling transparency of a second pixel area according to the received data from the second data line; and
a third sub-electrode control circuit electrically coupled to the second data line, the first scan line and the second scan line and for receiving the data transmitted from the second data line, changing the received data from the second data line by charge sharing subjected to the control of the second scan line and thereby controlling transparency of a third pixel area according to the changed data;
wherein the second scan line and the first scan line are sequentially enabled, and the second scan line is enabled after the first scan line is enabled.

7. The flat display panel according to claim 6, wherein
the first pixel area, the second pixel area and the third pixel area are arranged between the first data line and the second data line,
the first pixel area and the second pixel area are respectively arranged at two sides of the first scan line, and
the second pixel area and the third pixel area are arranged between the first scan line and the second scan line.

8. The flat display panel according to claim 6, wherein an area of the second pixel area is not larger than an area of the third pixel area.

9. The flat display panel according to claim 6, wherein
the first sub-electrode control circuit comprises:
a first switching element;
a first sub-electrode electrically coupled to the first switching element; and
a first storage capacitor electrically coupled to the first switching element through the first sub-electrode;
wherein the first switching element is electrically coupled between the first data line and the first storage capacitor and further electrically coupled to the first scan line, to thereby receive the data transmitted from the first data line and store the received data from the first data line in the first storage capacitor;
the second sub-electrode control circuit comprises:
a second switching element;
a second sub-electrode electrically coupled to the second switching element; and
a second storage capacitor electrically coupled to the second switching element through the second sub-electrode;
wherein the second switching element is electrically coupled between the second data line and the second storage capacitor and further electrically coupled to the first scan line, to thereby receive the data transmitted from the second data line and store the received data from the second data line in the second storage capacitor; and
the third sub-electrode control circuit comprises:
a third switching element;
a fourth switching element;
a third sub-electrode electrically coupled to the third switching element and the fourth switching element;
a third storage capacitor electrically coupled to the third switching element through the third sub-electrode; and
a charge sharing capacitor electrically coupled to the fourth switching element;
wherein the third switching element is electrically coupled between the second data line and the third storage capacitor and further electrically coupled to the first scan line, to thereby receive the data transmitted from the second data line and store the received data from the second data line in the third storage capacitor; and
wherein the fourth switching element is electrically coupled between the third storage capacitor and the charge sharing capacitor and further electrically coupled to the second scan line, to thereby control the third storage capacitor and the charge sharing capacitor to share charges with each other.

10. The flat display panel according to claim 6, wherein when the flat display panel is used for three-dimensional display, the first sub-electrode control circuit is kept in a turned-off state.

11. The flat display panel according to claim 6, wherein every two of the plurality of pixel circuits that are both electrically coupled to the first data line and the second data line are electrically coupled to different ones of the plurality of scan lines.

12. The flat display panel according to claim 6, wherein adjacent two of the plurality of pixel circuits that are both electrically coupled to the first data line and the second data line share a same one of the plurality of scan lines.

13. A flat display panel being operative in two-dimensional display mode and three-dimensional display mode and comprising:
a plurality of scan lines;
a plurality of data lines; and
a plurality of pixel circuits, at least one of the pixel circuits each electrically coupled to neighboring two of the data lines and neighboring two of the scan lines to thereby receive data transmitted from the neighboring two data lines and share charges subjected to the control of the neighboring two scan lines for image display;
wherein the at least one pixel circuit each is divided into a plurality of pixel areas, and one of the pixel area is prevented from displaying data in the three-dimensional display mode rather than the two-dimensional display mode.
